(19) United States
(12) Patent Application Publication
(10) Pub. No.: US 2024/0324503 A1
(43) Pub. Date: Oct. 3, 2024

(54) SYSTEM AND METHOD FOR AN AGRICULTURAL HARVESTER

(71) Applicants: CNH Industrial Belgium N.V., Zedelgem (BE); CNH Industrial Brasil Ltda., Bairro Vale do Sereno (BR)

(72) Inventors: Bart M.A. Missotten, Herent (BE); Andre Satoshi Seki, Bairro Boa Vista (BR); Yuanyuan Li, Leuven (BE); Marcos Ikeguchi Ohira, Rua Regente Feijó (BR); João Augusto Marcolin Lucca, Bairro Vila Nova (BR)

(21) Appl. No.: 18/618,704

(22) Filed: Mar. 27, 2024

Related U.S. Application Data
(60) Provisional application No. 63/454,815, filed on Mar. 27, 2023.

(51) Int. Cl. A01D 41/127; A01D 61/04

(52) U.S. Cl. CPC A01D 41/1271; A01D 61/04

(57) ABSTRACT

A system for an agricultural harvester system can include an elevator configured to receive a flow of a harvested material. A chain can have a first portion positioned above the elevator and a second portion positioned below the elevator. A sensor assembly can be positioned between the elevator and the second portion. The sensor assembly can have a field of view that is directed towards a top portion of the elevator and configured to generate a first set of data. A computing system can be communicatively coupled to the sensor assembly. The computing system can be configured to receive the first set of data and generate an estimated weight of the harvested material based at least partially on the first set of data associated with the harvested material transferred along the elevator during a defined interval.

### FIELD OF THE INVENTION

The present disclosure relates generally to agricultural harvesters, such as sugarcane harvesters, and, more particularly, to systems and methods for monitoring operational conditions of the agricultural harvester.

### BACKGROUND OF THE INVENTION

Agricultural harvesters can include an assembly of processing components for processing harvested material. For instance, within a sugarcane harvester, severed sugarcane stalks are conveyed via a feed roller assembly to a chopper assembly that cuts or chops the sugarcane stalks into pieces or billets (e.g., six-inch cane sections). The processed harvested material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device. In some cases, a secondary extractor may remove additional airborne debris (e.g., dust, dirt, leaves, etc.) before the remaining harvested material is delivered to the external storage device.

During the operation of the harvester, an amount of processed harvested material may be difficult to monitor. Accordingly, systems and methods for monitoring the amount of processed harvested material during the harvest operation would be welcomed in the technology.

### BRIEF DESCRIPTION OF THE INVENTION

Aspects and advantages of the invention will be set forth in part in the following description, or may be obvious from the description, or may be learned through practice of the invention.

In some aspects, the present subject matter is directed to a system for an agricultural harvester that includes an elevator configured to receive a flow of a harvested material. A chain has a first portion positioned above the elevator and a second portion positioned below the elevator. A sensor assembly is positioned between the elevator and the second portion. The sensor assembly has a field of view that is directed towards a top portion of the elevator and configured to generate a first set of data. A computing system is communicatively coupled to the sensor assembly. The computing system is configured to receive the first set of data and generate an estimated weight of the harvested material based at least partially on the first set of data associated with the harvested material transferred along the elevator during a defined interval.

In some aspects, the present subject matter is directed to a computer-implemented method for agricultural harvesting. The computer-implemented method includes translating harvested material along an elevator within a region defined between first and second paddles operably coupled with the elevator. The method also includes receiving, from a sensor assembly positioned below the region, data indicative of one or more operation-related conditions. Lastly, the method includes generating, with a computing system, an estimated weight of the harvested material based at least partially on the data during a defined interval.

In some aspects, the present subject matter is directed to a system for an agricultural harvester that includes an elevator configured to receive a flow of a harvested material. A chain has a first portion positioned above the elevator and a second portion positioned below the elevator. A sensor assembly is positioned between the elevator and the second portion. The sensor assembly having a field of view that is directed towards a top portion of the elevator and configured to generate data indicative of one or more operation-related conditions. A computing system is communicatively coupled to the sensor assembly. The computing system is configured to receive the data and generate an estimated leaf or stalk content based at least partially on the data associated with the harvested material transferred through along the elevator during a defined interval.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of an agricultural harvester in accordance with aspects of the present subject matter;

FIG. 2 illustrates a simplified, side view of an elevator assembly of the agricultural harvester in accordance with aspects of the present subject matter;

FIG. 3 illustrates a schematic view of a system for the harvester in accordance with aspects of the present subject matter; and

FIG. 4 illustrates a flow diagram of a method for agricultural harvesting in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part can be used with another embodiment to yield a still further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material along a path. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used herein, “harvested material” can include crop product, which may be in the form of stalks (or to be collected crop or after collected crop), billets (modified stalks or modified collected crop), and/or debris, which may be any object other than the stalks or the billets (or the collected crop) (e.g., dust, dirt, leaves, etc.).

In general, the present subject matter is directed to a system for an agricultural harvester. The system can include a material processing system configured to receive a flow of a harvested material.

A vision-based sensor assembly can be operably coupled with the material processing system and configured to generate a first set of data. A load sensor assembly can be operably coupled with the material processing system and configured to generate a second set of data. A computing system communicatively coupled to the vision-based sensor assembly and the load sensor assembly. In addition, one or more pressure sensor assemblies can include a first pressure sensor assembly and a second pressure sensor assembly spaced from the first pressure sensor assembly at a known distance and configured to measure fluid pressure within the elevator assembly and to output respective signals indicative of the measured pressure.

Based on the received inputs from the one or more load sensor assemblies and/or the one or more pressure sensor assemblies, the computing system may determine a mass of the harvested material. Additionally or alternatively, based on the received inputs from the one or more vision-based sensor assemblies, the computing system may determine a composition (e.g., percent of harvested material that is stalk, percent of harvested material that is leaves, percent of harvested material that is non-harvested material (dirt)) and/or a volume of the harvested material. The relationship between a volume and a mass of the harvested material is at least partially dependent on the density, humidity, leaf content, quality of cut, etc., and as a consequence, by using data received from the one or more load sensor assemblies, one or more pressure sensor assemblies, and/or the one or more vision-based sensor assemblies, a more accurate estimated weight of stalks and leaves with less frequent re-calibration by the operator or a more accurate re-distribution of mill weighbridge measured truck weights may be accomplished.

In addition, during operation, the computing system may also monitor an amount of debris and/or other material that is adhered to a component of the sensor system. If the amount of debris and/or other material exceeds a defined threshold, a cleaning routine may be initiated.

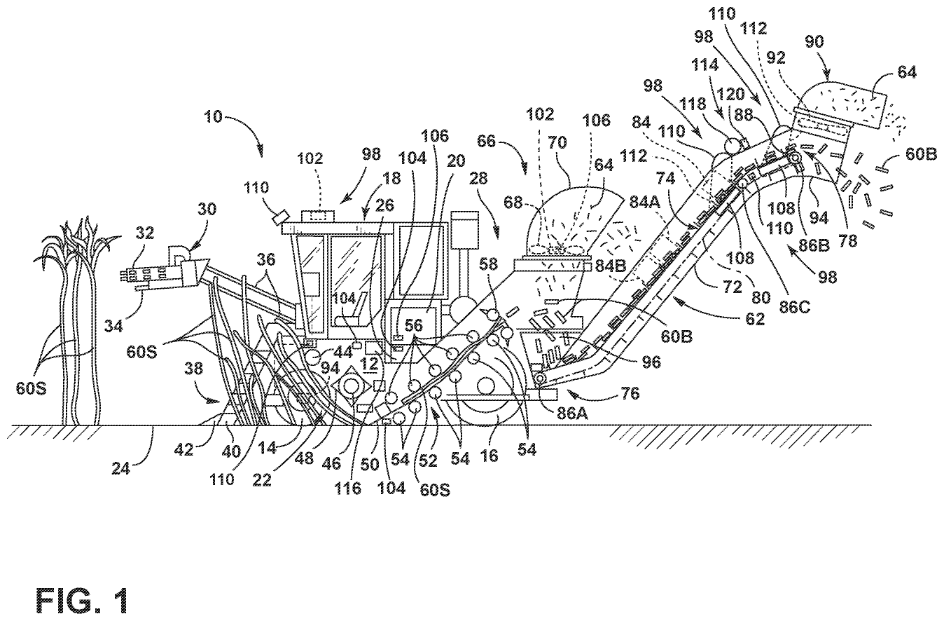

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable agricultural harvester.

As shown in FIG. 1, the harvester 10 can include a frame 12, a pair of front wheels 14, a pair of rear wheels 16, and an operator's cab 18. The harvester 10 may also include a power source 20 (e.g., an engine mounted on the frame 12) that powers one or both pairs of the wheels 14, 16 via a driveline assembly 22 (e.g., a transmission) to traverse a field 24. Alternatively, the harvester 10 may be a track-driven harvester and, thus, may include tracks driven by the power source 20 as opposed to the illustrated wheels 14, 16. The power source 20 may also drive a hydraulic fluid pump 26 configured to generate pressurized hydraulic fluid for a hydraulic circuit, which may be configured to power various components of the harvester 10, including the driveline assembly 22.

The harvester 10 may also include a material processing system 28 incorporating various components, assemblies, and/or sub-assemblies of the harvester 10 for cutting, processing, cleaning, and discharging sugarcane as the cane is harvested from an agricultural field 24. For instance, the material processing system 28 may include a topper assembly 30 positioned at the front end portion of the harvester 10 to intercept sugarcane as the harvester 10 is moved in a forward direction. As shown, the topper assembly 30 may include both a gathering disk 32 and a cutting disk 34. The gathering disk 32 may be configured to gather the sugarcane stalks 60S so that the cutting disk 34 may be used to cut off the top of each stalk 60S. As is generally understood, the height of the topper assembly 30 may be adjustable via a pair of arms 36, which may be hydraulically raised and lowered.

The material processing system 28 may further include a crop divider 38 that extends upwardly and rearwardly from the field 24. In general, the crop divider 38 may include two spiral feed rollers 40. Each feed roller 40 may include a ground shoe 42 at its lower end portion to assist the crop divider 38 in gathering the sugarcane stalks 60S for harvesting. Moreover, as shown in FIG. 1, the material processing system 28 may include a knock-down roller 44 positioned near the front wheels 14 and a fin roller 46 positioned behind the knock-down roller 44. As the knock-down roller 44 is rotated, the sugarcane stalks 60S being harvested are knocked down while the crop divider 38 gathers the stalks 60S from agricultural field 24. Further, as shown in FIG. 1, the fin roller 46 may include a plurality of intermittently mounted fins 48 that assist in forcing the sugarcane stalks 60S downwardly. As the fin roller 46 is rotated during the harvest, the sugarcane stalks 60S that have been knocked down by the knock-down roller 44 are separated and further knocked down by the fin roller 46 as the harvester 10 continues to be moved in the forward direction relative to the field 24.

Referring still to FIG. 1, the material processing system 28 of the harvester 10 may also include a base cutter assembly 50 positioned behind the fin roller 46. The base cutter assembly 50 may include blades for severing the sugarcane stalks 60S as the cane is being harvested. The blades, which may be located on a periphery section of the base cutter assembly 50, can be rotated by the hydraulic circuit. Additionally, in several embodiments, the blades may be angled downwardly to sever the base of the sugarcane as the cane is knocked down by the fin roller 46.

Moreover, the material processing system 28 may include a feed roller assembly 52 located downstream of the base cutter assembly 50 for moving the severed stalks 60S of sugarcane from base cutter assembly 50 along the processing path of the material processing system 28. As shown in FIG. 1, the feed roller assembly 52 may include a plurality of bottom rollers 54 and a plurality of opposed, top rollers 56. The various bottom and top rollers 54, 56 may be used to pinch the harvested sugarcane during transport. As the sugarcane is transported through the feed roller assembly 52, debris 64 (e.g., rocks, dirt, and/or the like) may be allowed to fall through bottom rollers 54 onto the field 24.

In addition, the material processing system 28 may include a chopper assembly 58 located at the downstream end section of the feed roller assembly 52 (e.g., adjacent to the rearward-most bottom roller 54 and the rearward-most top roller 56). In general, the chopper assembly 58 may be used to cut or chop the severed sugarcane stalks 60S into pieces or “billets” 60B, which may be, for example, six (6) inches long. The billets 60B may then be propelled towards an elevator assembly 62 of the material processing system 28 for delivery to an external receiver or storage device.

The debris 64 (e.g., dust, dirt, leaves, etc.) separated from the sugarcane billets 60B may be expelled from the harvester 10 through a primary extractor 66 of the material processing system 28, which may be located downstream of the chopper assembly 58 and may be oriented to direct the debris 64 outwardly from the harvester 10. Additionally, an extractor fan 68 may be mounted within an extractor housing 70 of the primary extractor 66 for generating a suction force or vacuum sufficient to force the debris 64 through the primary extractor 66. The separated or cleaned billets 60B, which may be heavier than the debris 64 expelled through the extractor 66, may then fall downward to the elevator assembly 62.

As shown in FIG. 1, the elevator assembly 62 may include an elevator housing 72 and an elevator 74 extending within the elevator housing 72 between a lower, proximal end portion 76 and an upper, distal end portion 78. In some examples, the elevator 74 may include a looped chain 80 and a plurality of flights or paddles 82 attached to and spaced on the chain 80. The paddles 82 may be configured to hold the sugarcane billets 60B on the elevator 74 as the sugarcane billets 60B are elevated along a top surface of the elevator 74 defined between its proximal and distal end portions 76, 78. A region 84 for retaining the harvested material may be defined between the first and second paddles 82 operably coupled with the elevator 74. As such, a first region 84A may be defined between first and second paddles 82, a second region 84B may be defined between the second and a third paddle 82, and so on. Additionally, the elevator 74 may include lower and upper sprockets 86A, 86B positioned at its proximal and distal end portions 76, 78, respectively. In some instances, the elevator 74 may include a first span, a second span downstream of the first span, and a third span downstream of the first span and the second span. In such examples, the second span can be offset from the first span and the third span may be offset from the first span and/or the second span. In some cases, an intermediate sprocket 86C can be positioned between the first span and the second span and between the second span and the third span.

As shown in FIG. 1, an elevator motor 88 may be coupled to one of the sprockets (e.g., the upper sprocket 86B) for driving the chain 80, thereby allowing the chain 80 and the paddles 82 to travel in a loop between the proximal and distal ends 76, 78 of the elevator 74.

Moreover, in some embodiments, debris 64 (e.g., dust, dirt, leaves, etc.) separated from the elevated sugarcane billets 60B may be expelled from the harvester 10 through a secondary extractor 90 of the material processing system 28 coupled to the rear end portion of the elevator housing 72. For example, the debris 64 expelled by the secondary extractor 90 may be debris 64 remaining after the billets 60B are cleaned and debris 64 expelled by the primary extractor 66. As shown in FIG. 1, the secondary extractor 90 may be located adjacent to the distal end portion 78 of the elevator 74 and may be oriented to direct the debris 64 outwardly from the harvester 10. Additionally, an extractor fan 92 may be mounted at the base of the secondary extractor 90 for generating a suction force or vacuum sufficient to force the debris 64 through the secondary extractor 90. The separated, cleaned billets 60B, heavier than the debris 64 expelled through the primary extractor 66, may then fall from the distal end portion 78 of the elevator 74. In some instances, the billets 60B may fall through an elevator discharge opening 94 defined by the elevator assembly 62 into an external storage device, such as a sugarcane billet cart.

During operation, the harvester 10 traverses the agricultural field 24 for harvesting sugarcane. After the height of the topper assembly 30 is adjusted via the arms 36, the gathering disk 32 on the topper assembly 30 may function to gather the sugarcane stalks 60S as the harvester 10 proceeds across the field 24, while the cutting disk 34 severs the leafy tops of the sugarcane stalks 60S for disposal along either side of harvester 10. As the stalks 60S enter the crop divider 38, the ground shoes 42 may set the operating width to determine the quantity of sugarcane entering the throat of the harvester 10. The spiral feed rollers 40 then gather the stalks 60S into the throat to allow the knock-down roller 44 to bend the stalks 60S downwardly in conjunction with the action of the fin roller 46. Once the stalks 60S are angled downward as shown in FIG. 1, the base cutter assembly 50 may then sever the base of the stalks 60S from field 24. The severed stalks 60S are then, by the movement of the harvester 10, directed to the feed roller assembly 52.

The severed sugarcane stalks 60S are conveyed rearwardly by the bottom and top rollers 54, 56, which compresses the stalks 60S, makes them more uniform, and shakes loose debris 64 to pass through the bottom rollers 54 to the field 24. At the downstream end portion of the feed roller assembly 52, the chopper assembly 58 cuts or chops the compressed sugarcane stalks 60S into pieces or billets 60B (e.g., 6-inch cane sections). The processed harvested material discharged from the chopper assembly 58 is then directed as a stream of billets 60B and debris 64 into the primary extractor 66. The airborne debris 64 (e.g., dust, dirt, leaves, etc.) separated from the billets 60B is then extracted through the primary extractor 66 using suction created by the extractor fan 68. The separated/cleaned billets 60B then be directed to an elevator hopper 96 into the elevator assembly 62 and travel upwardly via the elevator 74 from its proximal end portion 76 to its distal end portion 78. During normal operation, once the billets 60B reach the distal end portion 78 of the elevator 74, the billets 60B fall through the elevator discharge opening 94 to an external storage device. If provided, the secondary extractor 90 (with the aid of the extractor fan 92) blows out trash/debris 64 from the harvester 10, similar to the primary extractor 66.

In various examples, the harvester 10 may also include a sensor system 98 including various onboard sensor(s) for monitoring one or more operating parameters or conditions of the harvester 10. For instance, the sensor system 98 may include or be associated with various different speed sensor assemblies 102 for monitoring the speed of the harvester 10, and/or the operating speed of one or more components of the harvester 10. In several embodiments, the speed sensor assemblies 102 may be used to detect or monitor various different speed-related parameters associated with the harvester 10, including, but not limited to, the ground speed of the harvester 10, the engine speed of the harvester's engine (e.g., engine RPM), the elevator speed of the elevator assembly 62, the rotational speed of the blades of the base cutter assembly 50, the rotational speed of the chopper assembly 58, the rotational speed of the rollers 54, 56 of the feed roller assembly 52, the fan speed associated with the primary extractor 66 and/or the secondary extractor 90, and/or any other suitable operating speeds associated with the harvester 10. For example, as shown in FIG. 1, a first speed sensor assembly 102 is provided in operative association with the primary extractor 66 (e.g., a rotational speed sensor provided in association with the elevator motor 88) to allow the fan speed to be monitored, while a second speed sensor assembly 102 (e.g., a wheel speed sensor or a GPS-enabled device) may be provided in operative association with another component of the harvester 10 (e.g., the wheels 14, 16 and/or cab 18) to allow the ground speed of the harvester 10 to be continuously monitored.

Additionally, in several embodiments, the sensor system 98 may include or incorporate one or more position sensor assemblies 104 to monitor one or more corresponding position-related parameters associated with the harvester 10. Position-related parameters that may be monitored via the position sensor(s) 104 include, but are not limited to, the cutting height of the base cutter assembly 50, the relative positioning of the bottom and top rollers 54, 56 of the feed roller assembly 52, the vertical travel or position of the chassis or frame 12 of the harvester 10, and/or any other suitable position-related parameters associated with the harvester 10. For instance, as shown in FIG. 1, a position sensor assembly 104 may be mounted to the harvester's frame 12 to monitor the vertical position or travel of the chassis relative to a given reference point.

In some embodiments, the sensor system 98 may include or incorporate one or more load sensor assemblies 108 (e.g., a load sensor in the form of one or more load cells or sensorized load plates) to monitor one or more corresponding load-related conditions or parameters associated with the harvester 10. For instance, as shown in FIG. 1, one or more load sensor assemblies 108 may be provided in operative association with the elevator assembly 62 to allow the mass or mass flow rate of the harvested material being directed through the elevator 74 to be monitored. In various examples, a load sensor of the load sensor assembly 108 can be positioned proximate to the upper sprocket 86B of the elevator assembly 62 and/or proximate to the intermediate sprocket 86C of the elevator assembly 62.

Additionally or alternatively, in some examples, one or more load sensor assemblies 108 may be positioned within at least one paddle 82 of the elevator 74 with each of the one or more load sensor assemblies 108 communicatively coupled with a computing system.

Additionally, in some embodiments, the sensor system 98 may include or incorporate one or more vision-based or wave-based sensor assemblies 110 used to capture sensor data indicative of one or more observable conditions or parameters associated with the harvester 10, such as by providing a camera or LIDAR device to allow the potential upcoming stalk mass within the field 24 to be estimated based on the received vision-based data (e.g., image(s)) or by providing an internally installed camera or radar device to allow sensor data to be captured that is associated with a detected foliage ratio of the harvested material at the elevator 74 and/or within any of location of the harvester 10 and/or a mass of the harvested material through the material processing system 28. For instance, as shown in FIG. 1, a forward looking vision-based or wave-based sensor assembly 110 may be installed on the cab 18 with a field of view directed in front of the harvester 10 to allow images or other vision-based data to be captured that provides an indication of the upcoming stalk mass within the field 24. Additionally or alternatively, as shown in FIG. 1, a vision-based or wave-based sensor assembly 110 may be installed proximate to the knock-down roller 44 with a field of view directed towards an infeed location of the harvested material entering the harvester 10 to allow images or other vision-based data to be captured that provides an indication of the upcoming stalk mass within the field 24. Additionally or alternatively, as shown in FIG. 1, one or more vision-based sensor assemblies 110 may be installed proximate to the elevator housing 72 with a field of view directed towards the elevator 74 to allow images or other vision-based data to be captured that provide an indication of the debris 64 and/or billets 60B, (i.e., detected foliage ratio) downstream of the primary extractor 66. In such instances, the vision-based or wave-based sensor assembly 110 may be positioned above the elevator 74 and/or below the elevator 74. Additionally or alternatively, one or more load sensor assemblies 108 may be utilized in combination with one or more vision-based sensor assemblies 110 integrated into the elevator floor such that a panel protecting the camera and/or a lens of the camera is cleaned by the crop flow friction. In such instances, the vision-based sensor may be used for composition measurement.

As illustrated in FIG. 1, the vision-based or wave-based sensor assembly 110 may include a field of view 112 that is directed towards a top portion of the elevator 74. Moreover, the field of view 112 may overlap with a common region 84 with the load sensor assembly 108. In such instances, the vision-based or wave-based sensor assembly 110 and the load sensor assembly 108 may be configured to determine a conditions or parameters associated with the harvester 10 with reference to a common region 84.

In various examples, a cleaning system 114 may be installed on the harvester 10. The cleaning system 114 may be operatively coupled with the sensor system 98. In such instances, the cleaning system 114 may be configured to remove debris 64 and/or any other material from a component of the sensor system 98. Additionally or alternatively, the cleaning system 114 may be operatively coupled with any other component of the harvester 10. In some cases, the cleaning system 114 may provide a liquid and/or pressurized air to the to be cleaned surface, component, or assembly. Additionally or alternatively, the cleaning system 114 may include a scraper 142 that physically removes debris 64 and/or any other material from a component of the sensor system 98.

In some examples, the harvester 10 can include a heating ventilation, and air conditioning (HVAC) system 116 that is operatively coupled with the cab 18 and/or any other component of the harvester 10. During the operation of the HVAC system 116, a heat exchange fluid circulates in a closed system that can include a compressor, a first heat exchanger (e.g., a condenser), a flow restriction, and a second heat exchanger called an evaporator. As ambient air passes over the evaporator and is cooled it is no longer able to hold the quantity of moisture present as water vapor. In turn, droplets of liquid water condense. This fluid may be collected and stored within a reservoir 118 for use by the cleaning system 114. In such instances, a pump 120 may be operably coupled with the HVAC system 116 and the reservoir 118 to move the fluid therebetween. Moreover, the pump 120 may be further configured to move the fluid from the reservoir 118 to one or more nozzles 122 within the cleaning system 114.

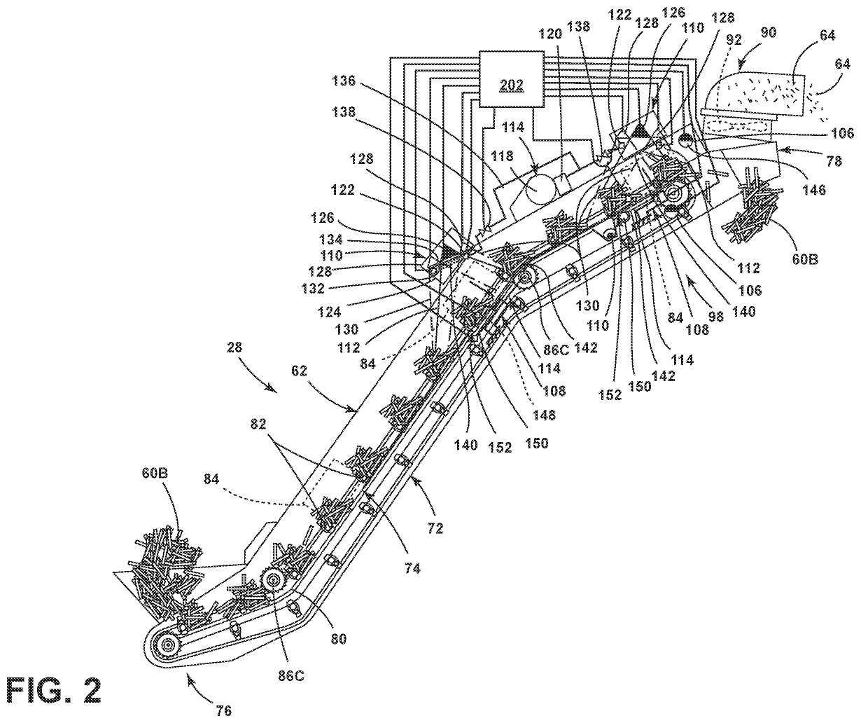

Referring now to FIG. 2, the vision-based or wave-based sensor assembly 110 may be operably coupled with the elevator housing 72. The vision-based or wave-based sensor assembly 110 may include a sensor housing 124, one or more vision-based sensors 126 installed within the sensor housing 124, and one or more light sources 128 configured to illuminate an area 130 within the field of view 112 of the one or more vision-based sensors 126.

The one or more vision-based sensors 126 may be operably coupled with a computing system 202. The one or more vision-based sensors 126 may produce a field of view 112 that can be directed towards the elevator 74 to allow images or other vision-based data to be captured that provides an indication of the harvested material (e.g., debris 64 and/or billets 60B) within the field of view 112. In various examples, each of the one or more vision-based sensor assemblies 110 may include an area-type image sensor, such as a CCD or a CMOS image sensor, and image-capturing optics that capture an image of the field of view 112. In various embodiments, the vision-based sensor 126 may correspond to a stereographic camera having two or more lenses with a separate image sensor for each lens to allow the camera to capture stereographic or three-dimensional images. It will be appreciated that the vision-based or wave-based sensor assembly 110 may additionally or alternatively include radar sensors, ultrasound sensors, LIDAR devices, etc. without departing from the teachings provided herein.

The one or more light sources 128 may be operably coupled with the computing system 202. The one or more light sources 128 can be configured to illuminate an area within the field of view 112 of the one or more vision-based sensors 126. The one or more light sources 128 may be any lighting apparatuses suitable for illuminating a portion of the elevator 74, such as light-emitting diodes (LED), tungsten-based light sources, halogen-based light sources, high-intensity discharge (HID) sources, such as xenon, laser-based light sources, vertical-cavity surface-emitting laser-based light sources (VCSEL), etc. In some instances, the one or more light sources 128 can be near-infrared (NIR) lamps positioned near the sensor assemblies 110 to illuminate the environment in low-light conditions for the sensor assemblies 110.

A panel 132 may be positioned along a carrier 134 between the one or more light sources 128 and/or the vision-based sensor 126 and the elevator 74. The panel 132 may be configured from any practicable material and include one or more transparent or translucent portions that define a light source focal region of the panel 132 and/or a vision-based sensor focal region of the panel 132.

With further reference to FIG. 2, the cleaning system 114 may be configured to provide a liquid and/or pressurized air on the panel 132. In some examples, the cleaning system may additionally or alternatively include a wiper assembly 140. In some instances, the nozzle 122 may be movable with the wiper assembly 140 and/or otherwise positioned to practicably clean the panel 132. The wiper assembly 140 can include an arm, a wiper operably coupled with the arm, and an actuator configured to alter a position of the arm and the wiper. The actuator may be operably coupled with the carrier 134 and the computing system. The wiper may be any practicable product that contacts the panel 132 to remove liquid, the debris 64, and/or any other material from a surface of the panel 132.

Referring still to FIG. 2, the sensor system 98 may include or incorporate one or more load sensor assemblies 108 (e.g., one or more load cells or sensorized load plates) to monitor one or more corresponding load-related conditions or parameters associated with the harvester 10. For instance, as shown in FIG. 2, the load sensor assembly 108 may be provided in operative association with the elevator assembly 62 to allow the mass or mass flow rate of the harvested material being directed along the elevator 74 to be monitored. In some cases, the cleaning system 114 may additionally or alternatively be configured to remove liquid, debris 64, and/or any other material from the load sensor assembly 108. In some instances, the cleaning system 114 may additionally or alternatively include at least one scraper 142 to remove at least a portion of the debris and/or other material that is adhered to the load sensor (or another component of the sensor system 98).

In some examples, the sensor system 98 may include or incorporate one or more pressure sensor assemblies 106. For example, a first pressure sensor assembly 106 incorporating a pressure sensor 146 may be configured to measure fluid pressure on a first side of the load sensor assembly 108. A second pressure sensor assembly 106 incorporating a pressure sensor 146 may be spaced from the first pressure sensor 146 at a known distance and configured to measure fluid pressure on a second opposing side of the load sensor assembly 108. The pressure sensors 146 are configured to measure the fluid pressure within the elevator assembly 62 and to output respective signals indicative of the measured pressure.

In some cases, when there is no or a small amount of harvested material flow along the elevator 74, the secondary extractor may create a larger under pressure causing the one or more load sensor assemblies 108 to show a negative mass and/or otherwise distort the mass of the harvested material. As such, when the elevator 74 is running empty (which may be detected by the vision-based or wave-based sensor assembly 110), a pressure relationship between air pressures as detected by the first pressure sensor assembly 106 and the second pressure sensor assembly 106 may be determined by the computing system. In turn, the pressure relationship may be used to tare (or otherwise set an initial mass value) of the one or more load sensor assemblies 108. In various examples, the pressure sensors 146 may be configured as fiber optic sensors, mechanical deflection sensors, piezoelectric sensors, microelectromechanical system (MEMS) sensors, or any other suitable sensor configured to output a signal indicative of fluid pressure.

With further reference to FIGS. 2, the sensor system 98 may include one or more movement sensor assemblies 148, such as a proximity sensor, which may be configured to detect when a component of the harvester 10, such as a paddle 82 on the elevator 74, changes position relative to the movement sensor assembly 148. As such, while the elevator 74 is in motion, the movement sensor assembly 148 may detect a time between paddles 82 passing thereby and/or quantify the speed of the elevator 74 and various regions 84 associated with the elevator 74 in any other manner. In some examples, a weight of the region 84 of the elevator may be determined when the movement sensor assembly 148 detects a paddle 82 to be in a defined position to avoid material that is stuck between the paddle 82 and the load sensor assembly 108 from producing high-forces on the load sensor assembly 108, which could create error in the weight determination of the load sensor assembly 108.

In operation, the vision-based or wave-based sensor assembly 110 may be configured to generate data that is associated with one or more “operation-related” conditions. In some instances, the operation-related conditions may be related to a leaf or stalk content, a cutting quality, ratoons being cut out due to bad setting of the base cutter, a volume of harvested material, and/or any other operation-related conditions. Similarly, the one or more load sensor assemblies 108 may be configured to generate data that is associated with one or more “operation-related” conditions. In some instances, the operation-related conditions may be related to a mass of material transported over the load sensor. In various examples, the mass may be based on an adjusted mass based on a pressure relationship that is generated by a pressure sensor assembly 106.

Based on the received inputs from the one or more load sensor assemblies 108 and/or the one or more pressure sensor assemblies 106, the computing system may determine a mass of the harvested material. Additionally or alternatively, based on the received inputs from the one or more vision-based sensor assemblies 110, the computing system may determine a composition (e.g., percent of harvested material that is stalk, percent of harvested material that is leaves, percent of harvested material that is non-harvested material (dirt)) and/or a volume of the harvested material. The relationship between a volume and a mass of the harvested material is at least partially dependent on the density, humidity, leaf content, quality of cut, etc., and as a consequence, by using data received from the one or more load sensor assemblies 108, the one or more pressure sensor assemblies 106, and/or the one or more vision-based sensor assemblies 110, a more accurate estimated weight of stalks and leaves with less frequent re-calibration by the operator or a more accurate re-distribution of mill weighbridge measured truck weights may be accomplished.

During operation, the computing system may also monitor an amount of debris 64 and/or other material that is adhered to a component of the sensor system 98 (e.g., the panel 132). If the amount of debris 64 and/or other material exceeds a defined threshold, a cleaning routine may be initiated. In such instances, a computing system 202 may activate the pump 120 thereby directing fluid from the reservoir 118 through the pipe 136. In addition, the computing system may actuate a valve 138 positioned between the pump 120 and each nozzle 122 to direct liquid at the panel 132. The computing system 202 may be capable of various cleaning routines that include spraying air and liquid contemporaneously and/or successively at the panel 132, just liquid at the panel 132, and/or just air at the panel 132.

Similarly, the computing system may also monitor an amount of debris 64 and/or other material that is adhered to the load sensor (or another component of the load sensor assembly 108). If the amount of debris 64 and/or other material exceeds a defined threshold, a cleaning routine may be initiated. In such instances, a computing system 202 may activate at least one scraper 142 to remove at least a portion of the debris 64 and/or other material that is adhered to the load sensor (or another component of the load sensor assembly 108). In some instances, the at least one scraper 142 can be driven by the chain 80 of the elevator assembly 62 and/or any other device. In various cases, a portion of the chain 80 can be configured to drive a roller 150 to clear a gap 152 at the entrance of the load sensor assembly 108. However, the debris 64 and/or other material that is adhered to the load sensor (or another component of the load sensor assembly 108) may be removed in any manner by the cleaning system 114 without departing from the scope of the present disclosure.

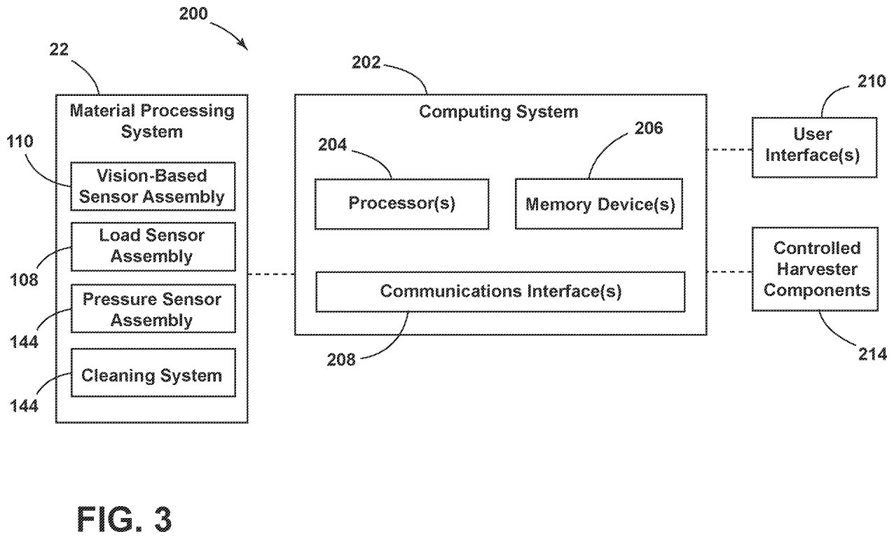

Referring now to FIG. 3, a schematic view of a system 200 for monitoring the harvested material yield of an agricultural harvester 10 is illustrated in accordance with aspects of the present subject matter. In general, the system 200 will be described herein with reference to the agricultural harvester 10 and associated components described above with reference to FIGS. 1 and 2. However, it will be appreciated that the disclosed system 200 may be implemented with harvesters having any other suitable configurations.

As shown in FIG. 3, the system 200 may include a computing system 202 and various other components 214 configured to be communicatively coupled to and/or controlled by the computing system 202. For instance, the computing system 202 may be communicatively coupled to the vision-based or wave-based sensor assembly 110 that captures a first set of data, such as image data or image-like data of the harvested material directed through the material processing system 28 of the harvester 10. Additionally or alternatively, the computing system 202 may also be communicatively coupled to the one or more load sensor assemblies 108 that capture data associated with a second set of data, which may be indicative of a mass of the harvested material directed through the material processing system 28 of the harvester 10. Additionally or alternatively, the computing system 202 may also be communicatively coupled to the one or more pressure sensor assemblies 106 that captures a third set of data, which may be associated with a pressure relationship about the load sensor assembly 108 of the harvester 10. Additionally or alternatively, the cleaning system 114 may be operatively coupled with the sensor system 98. In such instances, the cleaning system 114 may be configured to remove debris 64 and/or any other material from a component of the sensor system 98.

In general, the computing system 202 may be configured as any suitable processor-based device, such as a computing device or any suitable combination of computing devices. Thus, in several embodiments, the computing system 202 may include one or more processor(s) 204, and the associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application-specific integrated circuit, and other programmable circuits. Additionally, the memory device(s) 206 of the computing system 202 may generally comprise memory element(s) including, but not limited to, a computer-readable medium (e.g., random access memory RAM)), a computer-readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods and algorithms that will be described herein.

It will be appreciated that, in several embodiments, the computing system 202 may correspond to an existing controller of the agricultural harvester 10. However, it will be appreciated that the computing system 202 may instead correspond to a separate processing device. For instance, in some examples, the computing system 202 may form all or part of a separate plug-in module that may be installed within the agricultural harvester 10 to allow for the disclosed system and method to be implemented without requiring additional software to be uploaded onto existing control devices of the agricultural harvester 10.

As provided herein, based on the received inputs from the one or more vision-based sensor assemblies 110, the computing system may determine a composition (e.g., percent of harvested material that is stalk, percent of harvested material that is leaves, percent of harvested material that is non-crop material (dirt)) and/or a volume of the harvested material. For example, the computing system can utilize any suitable image processing algorithm(s) to determine the amount of debris 64 (FIG. 1) on a component (e.g., the panel 132 (FIG. 2) within the data provided by the sensor system 98. In some embodiments, a texture-based algorithm may be utilized that relies on the orientations of image gradients to differentiate a billet or other debris 64 (FIG. 1) that is transferred along the elevator 74. In other embodiments, a color-based algorithm may be utilized that relies on color differences to differentiate between a billet or other debris 64 (FIG. 1). In further embodiments, the algorithm may identify the differences in the reflectivity or spectral absorption between a billet or other debris 64 (FIG. 1). It will be appreciated, however, that any suitable image processing algorithm(s) may be utilized to determine the operation-related condition.

Additionally or alternatively, based on the received inputs from the one or more load sensor assemblies 108 and/or the one or more pressure sensor assemblies 106, the computing system may determine a mass of the harvested material. For example, the computing system 202 may include one or more suitable relationships and/or algorithms stored within its memory 206 that, when executed by the processor 204, allow the computing system 202 to estimate or determine the mass of the harvested material through the material processing system 28 based at least in part on the sensor data provided by the one or more load sensor assemblies 108 (which may be adjusted based on a pressure relationship based on the data from the one or more pressure assemblies). Additionally, or alternatively, the memory 206 may implement machine learning methods and algorithms that utilize one or several machine learning techniques including, for example, decision tree learning, including, for example, random forest or conditional inference trees methods, neural networks, support vector machines, clustering, and Bayesian networks. In some instances, the machine learning engine may allow for changes to be performed without human intervention.

The relationship between a volume and a mass of the harvested material is at least partially dependent on the density, humidity, leaf content, quality of cut, etc., and as a consequence, by using data received from the one or more load sensor assemblies 108, the one or more pressure sensor assemblies 106, and/or the one or more vision-based sensor assemblies 110, the computing system may determine an estimated weight of stalks and leaves with less frequent re-calibration by the operator and/or a more accurate re-distribution of mill weighbridge measured truck weights.

The computing system 202 may also be configured to initiate or execute one or more control actions. For example, the control actions may include generating a notification of an estimated weight of stalks and leaves, a re-distribution of mill weighbridge measured truck weights, an estimated weight of stalks and leaves exceeding a defined threshold, a re-distribution of mill weighbridge measured truck weights exceeding a defined threshold, and/or any other information. Moreover, a notification may be generated when an estimated when an amount of harvested material, as determined from the data provided from the vision-based or wave-based sensor assembly 110 fails to correlate (e.g., within a defined range) with a mass of the harvested material based on data from the one or more load sensor assemblies 108 and/or the one or more pressure sensor assemblies 106.

In some examples, the computing system 202 may be communicatively coupled to and/or configured to control a user interface 210. The user interface 210 described herein may include, without limitation, any combination of input and/or output devices that allow an operator to provide inputs to the computing system 202 and/or that allow the computing system 202 to provide feedback to the operator, such as a keyboard, display, keypad, pointing device, buttons, knobs, a touch-sensitive screen, mobile device, audio input device, audio output device, and/or the like. The notifications generated by the computing system may be provided to the user interface.

Additionally or alternatively, the one or more control actions may include initiating a cleaning routine. In some instances, the cleaning routine may be initiated when a detected amount of debris 64 (FIG. 1) on a component of at least one of the one or more load sensor assemblies 108, the one or more pressure sensor assemblies 106, and/or the one or more vision-based sensor assemblies 110 exceeds a defined threshold. In various examples, determining a detected amount of debris 64 (FIG. 1) on a component of at least one of the one or more load sensor assemblies 108, the one or more pressure sensor assemblies 106, and/or the one or more vision-based sensor assemblies 110 may include utilizing any suitable image processing algorithm(s) to determine the amount of debris 64 (FIG. 1) on a component (e.g., the panel 132) within the data provided by the sensor system 98. Additionally or alternatively, the cleaning routine may be initiated when an amount of harvested material, as determined from the data provided from the vision-based or wave-based sensor assembly 110 fails to correlate (e.g., within a defined range) with a mass of the harvested material based on data from the one or more load sensor assemblies 108 and/or the one or more pressure sensor assemblies 106.

The cleaning routine may include providing information to a user interface in the form of a suggestion to clean the component of at least one of the one or more load sensor assemblies 108, the one or more pressure sensor assemblies 106, and/or the one or more vision-based sensor assemblies 110. Additionally or alternatively, the cleaning routine can include activating a pump 120 to direct fluid from a reservoir 118 through a nozzle 122 and toward the component of at least one of the one or more load sensor assemblies 108, the one or more pressure sensor assemblies 106, and/or the one or more vision-based sensor assemblies 110. Additionally or alternatively, the cleaning routine can include activating an air pump to direct air through an air nozzle and toward the component of at least one of the one or more load sensor assemblies 108, the one or more pressure sensor assemblies 106, and/or the one or more vision-based sensor assemblies 110.

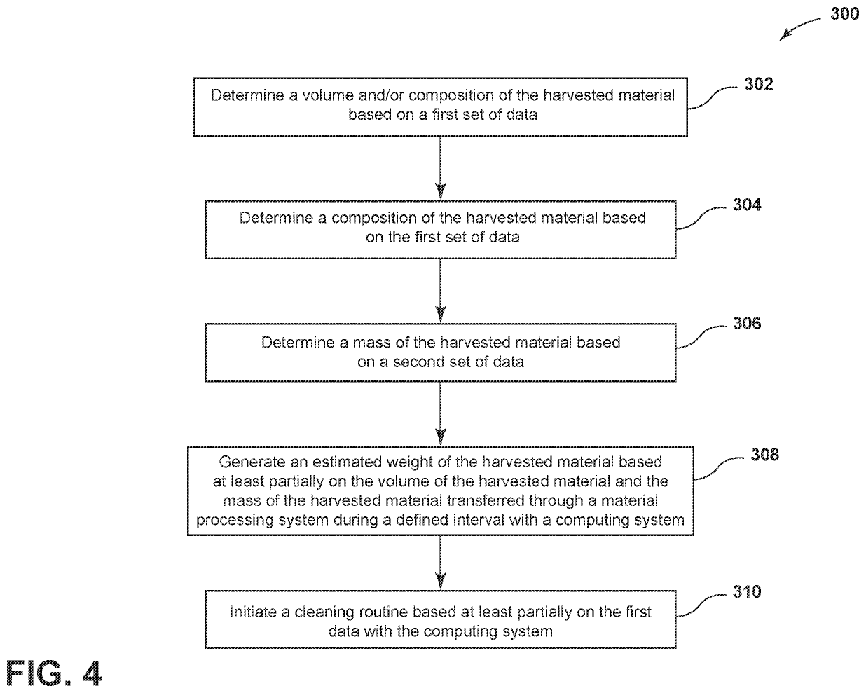

Referring now to FIG. 4, a flow diagram of a method 300 for agricultural harvesting is illustrated in accordance with aspects of the present subject matter. In general, the method 300 will be described herein with reference to the agricultural harvester 10 and related components described with reference to FIGS. 1 and 2, and the various components of the system 200 described with reference to FIG. 3. However, it will be appreciated that the disclosed method 300 may be implemented with harvesters having any other suitable configurations and/or within systems having any other suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4 at (302), the method 300 may include determining a volume and/or a composition of the harvested material based on a first set of data with a vision-based or wave-based sensor assembly. The vision-based or wave-based sensor assembly may be used to capture sensor data indicative of one or more observable conditions or parameters associated with the harvester. At (304), the method 300 can include determining a composition of the harvested material based on the first set of data from the vision-based or wave-based sensor assembly.

At (306), the method 300 can include determining a mass of the harvested material based on a second set of data from a load sensor assembly. The load sensor assembly (e.g., a load sensor in the form of one or more load cells or sensorized load plates) may be to monitor one or more corresponding load-related conditions or parameters associated with the harvester 10. For instance, the load sensor assembly may be provided in operative association with an elevator assembly to allow the mass or mass flow rate of the harvested material being directed along the elevator to be monitored.

At (308), the method 300 can include generating an estimated weight of the harvested material based at least partially on the volume of the harvested material and the mass of the harvested material transferred through a material processing system during a defined interval with a computing system. The defined interval may be a time in which a remote storage device is operably aligned with the harvester, and/or any other interval of time. Based on the received inputs from the load sensor assembly, the computing system may determine a mass of the harvested material. Additionally, based on the received inputs from the vision-based or wave-based sensor assembly, the computing system may determine a composition (e.g., percent of harvested material that is stalk, percent of harvested material that is leaves, percent of harvested material that is non-harvested material (dirt)) and/or a volume of the harvested material. The relationship between a volume and a mass of the harvested material is at least partially dependent on the density, humidity, leaf content, quality of cut, etc., and as a consequence, by using data received from the load sensor assembly and/or the vision-based or wave-based sensor assembly, a more accurate estimated weight of stalks and leaves with less frequent re-calibration by an operator and/or a more accurate re-distribution of mill weighbridge measured truck weights may be accomplished.

At (310), the method can include initiating a cleaning routine based at least partially on the first data with the computing system. In some examples, the computing system initiates the cleaning routine when a detected amount of debris is greater than or equal to a threshold amount based at least partially on the first set of data. The cleaning routine is configured to remove at least a portion of the detected debris from a component of the vision-based or wave-based sensor assembly or the load sensor assembly.

In various examples, the method 300 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update any performed processes. In some instances, the machine learning engine may allow for changes to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for an agricultural harvester, the system comprising:
an elevator configured to receive a flow of a harvested material;
a chain having a first portion positioned above the elevator and a second portion positioned below the elevator;
a sensor assembly positioned between the elevator and the second portion, the sensor assembly having a field of view that is directed towards a top portion of the elevator and configured to generate a first set of data; and
a computing system communicatively coupled to the sensor assembly, the computing system configured to:
receive the first set of data; and
generate an estimated weight of the harvested material based at least partially on the first set of data associated with the harvested material transferred along the elevator during a defined interval.

2. The system of claim 1, wherein the sensor assembly includes a vision-based sensor.

3. The system of claim 2, wherein the vision-based sensor is a stereographic camera having two or more lenses with a separate image sensor for each lens.

4. The system of claim 1, wherein the sensor assembly includes a wave-based sensor.

5. The system of claim 4, wherein the wave-based sensor is a LIDAR device.

6. The system of claim 1, wherein the sensor assembly includes a vision-based sensor and a wave-based sensor.

7. The system of claim 1, further comprising:
a load sensor assembly operably coupled with the elevator and configured to generate a second set of data.

8. The system of claim 7, wherein the computing system is configured to determine a mass of the harvested material based on the second set of data.

9. The system of claim 7, further comprising:
a cleaning system configured to remove debris from a component of at least one of the sensor assembly,
wherein the computing system is configured to initiate a cleaning routine with the cleaning system when a detected amount of debris is greater than or equal to a threshold amount based at least partially on the first set of data.

10. The system of claim 9, wherein the cleaning routine is configured to remove at least a portion of the detected amount of debris from a sensor of the sensor assembly.

11. The system of claim 9, wherein the cleaning routine is configured to remove at least a portion of the detected amount of debris from a load sensor of the load sensor assembly.

12. The system of claim 7, further comprising:
a pressure sensor assembly including a first pressure sensor on a first side of the load sensor assembly and a second pressure sensor spaced from a first pressure sensor, the first pressure sensor and the second pressure sensor each configured to measure a fluid pressure within the elevator, and wherein the computing system is further configured to:
determine a pressure relationship between the respective air pressures as detected by the first pressure sensor and the second pressure sensor; and
determine an initial mass value of the load sensor assembly based at least partial on the pressure relationship.

13. A computer-implemented method for agricultural harvesting, the computer-implemented method comprising:
translating harvested material along an elevator within a region defined between first and second paddles operably coupled with the elevator;
receiving, from a sensor assembly positioned below the region, data indicative of one or more operation-related conditions; and
generating, with a computing system, an estimated weight of the harvested material based at least partially on the data during a defined interval.

14. The computer-implemented method of claim 13, wherein further comprising:
determining, with the sensor assembly, a composition of the harvested material based on the data.

15. The computer-implemented method of claim 13, initiating, with the computing system, a cleaning routine based at least partially on the data.

16. A system for an agricultural harvester, the system comprising:
an elevator configured to receive a flow of a harvested material;
a chain having a first portion positioned above the elevator and a second portion positioned below the elevator;
a sensor assembly positioned between the elevator and the second portion, the sensor assembly having a field of view that is directed towards a top portion of the elevator and configured to generate data indicative of one or more operation-related conditions; and
a computing system communicatively coupled to the sensor assembly, the computing system configured to:
receive the data; and
generate an estimated leaf or stalk content based at least partially on the data associated with the harvested material transferred through along the elevator during a defined interval.

17. The system of claim 16, wherein the computing system is further configured to generate an estimated weight of the harvested material based at least partially on the data associated with the harvested material transferred along the elevator during the defined interval.

18. The system of claim 16, wherein the computing system is further configured to determine a percent of harvested material that is stalk based at least partially on the data associated with the harvested material transferred along the elevator during the defined interval.

19. The system of claim 16, wherein the computing system is further configured to determine a percent of harvested material that is leaves based at least partially on the data associated with the harvested material transferred along the elevator during the defined interval.

20. The system of claim 16, wherein the computing system is further configured to determine a percent of harvested material that is non-harvested material based at least partially on the data associated with the harvested material transferred along the elevator during the defined interval.
